(19) United States
(12) Patent Application Publication
(10) Pub. No.: US 2004/0012803 A1
(43) Pub. Date: Jan. 22, 2004

(54) System and method of a scanning moudle incorporated with a printer head

(75) Inventor: Chui-Kuei Chiu, Hsin-Chu (TW)

Correspondence Address: LOWE, HAUPTMAN,, GOPSTEIN & BERNER, LLP, Suite 310, 1700 Diagonal Road, Alexandria, VA, 22314, US

(73) Assignee: UMAX DATA SYSTEMS INC.

(21) Appl. No.: 10/199,001

(22) Filed: Jul. 22, 2002

(51) Int. Cl. H04N 1/207; H04N 1/024; G06K 15/02

(52) U.S. Cl. 358/1.13; 358/472

(57) ABSTRACT

The present invention discloses the system and method of a scanning module with an incorporated printer head. The method includes using a scanning head of scanner to scan an objects image pattern, using the printer head of scanner to print the object image pattern on a printing paper. Wherein the printer head and the scanning head use the same motor drive and driving component, and uses a control module to adjust the driving mode of the scanning head and the printer head. The system includes a scanning module for scanning an object image pattern, a printing module for printing the object image pattern, wherein the printing module is incorporated in the scanning module, a motor drive for driving the scanning module and the printing module, and a control module for adjusting driving mode of the scanning module and the printing module, thereby showing the object image pattern on a printing paper by using the printing module function.

### BACKGROUND OF THE INVENTION

1. Field of the Invention

The present invention relates to a multi-function peripheral, and more specifically, to the system and method of a scanning module incorporated with a printer head.

2. Description of the Prior Art

Multi-function peripheral( MFP) in the prior art incorporates an image scanner with a printing module, but the multi-function peripheral is functionally operated separately. The scanning module and printing module have one motor drive and driving component, respectively. This not only wastes material and cost as well as adds volumn, but also not benefit to minimize.

FIG. 1 is the cross sectional view of a multi-function peripheral 100 according to the prior art. Document 102 is placed upside down on the scanning flat-top building 104. Image data can be acquired by scanning the document 102, and transform to an electronic signal that can be processed by other devices or other similar devices. Scanning head 106 moves horizontally under the scanning flat-top building 104 to execute scanning action. The scanning head 106 includes a linear light source 108, a mirror set 110, a lens 114 and a light sensor 116. A first motor 112A is mechanically engaged with the scanning head 106 by gears, cables and other similar components to drive the scanning head 106 by moving lengthwise, in the direction of the scanning flat-top building 104. The reflected light from the scanning flat-top building 104 through the mirror set 110 and the lens 114 focuses on the light sensor 116. A printer head 124 is combined with the scanning head 106 on top of the scanning head 106. A second motor 112B is mechanically engaged with the printer head 124 by gears, cables and other similar components to drive the printer head 124 along the length in the direction of the scanning flat-top building 104.

The light sensor 116 is preferably a charge-coupled device, which has a plurality of detector cells that form a linear array. Each detector cell defines a document pixel. The scanned image data from the light sensor 116 is transmitted to a first control circuit 122A to transform the image data into digital signals. The first control circuit 122A also provides a driving signal to the first motor 112A, and the second control circuit 122B provides a driving signal to the second motor 112B. The first control circuit 122A can execute data transmission and be processed by a first output cable 126A and a central processor. The second control circuit 122B can execute data transmission and be processed by a second output cable 126B and another central processor.

The multi-function peripheral in the prior art selects and adopts the horizontal placing method, and its scanning flat-top building 104 is parallel with placing surface. The scanning head 106 moves along length and direction of the scanning flat-top building 104 by the first motor 112A to perform image acquisition of the scanned object. The first control circuit 122A must provide a driving signal to the first motor 112A. The printer head 124 moves along length direction of the scanning flat-top building 104 by the second motor 112B to perform a print of the scanned object. The second control circuit 122B must provide a driving signal to the second motor 112B. Therefore, the multi-function peripheral in the prior art occupies larger placing space, and needs two driving motor devices to drive the scanning head 106 and the printer head 124. Moreover, the power supply is provided to the driving motor device.

For the above reasons, it is desired to find a more preferable method and system.

### SUMMARY OF THE INVENTION

Owing to traditional MFP drawbacks in the prior art, the present invention provides the system and method of a scanning module incorporated with a printer head to reduce one set, a motor drive and a driving component.

The main object of the present invention is to provide a system and method of a scanning module incorporated with a printer head to save material cost.

The other object of the present invention is to provide a system and method for a scanning module incorporated with a printer head to save volumn as well as benefit to minimize.

The further object of the present invention provides a system and method for a scanning module incorporated with a printer head to adjust the buffer memory size by various scanning and printing settings.

According to the above object, the invention discloses a system and method for a scanning module incorporated with a printer head. The invention discloses the system and method of a scanning module incorporated with a printer head. The method includes using the scanning head of a scanner to scan an objects image pattern, and using a printer head of a scanner to print the object image pattern on printing paper. Wherein the printer head and the scanning head use the same motor drive and driving components, and using a control module to adjust the driving mode of the scanning head and the printer head. The system includes a scanning module for scanning an objects image pattern, a printing module for printing the objects image pattern, wherein the printing module is incorporated in the scanning module, a motor drive for driving the scanning module and the printing module, and a control module for adjusting the driving mode of the scanning module and the printing module, thereby showing the objects image pattern on printing paper by using the printing module function.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is the cross section view of a multi-function peripheral according to the prior art.

FIG. 2 is the cross section view of a scanning module with incorporated printer head according to the present invention.

FIG. 3 is the flow chart of a system of scanning module with incorporated printer head according to the present invention.

FIG. 4 is the flow chart of a method for scanning module with incorporated printer head according to the present invention.

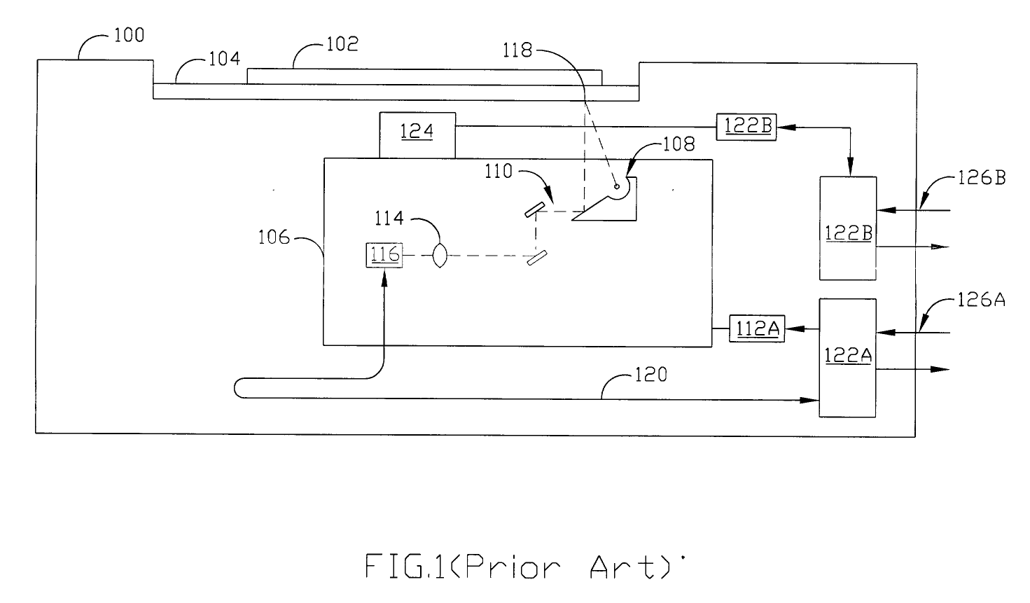

### DESCRIPTION OF THE PREFERRED EMBODIMENT

Some sample embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

In one embodiment, a method and system of a scanning module incorporated with a printer head is disclosed.

The method includes using the scanning head of a scanner to scan the objects image pattern, using the printer head of scanner to print the objects image pattern on printing paper. Wherein the printer head and the scanning head use the same motor drive and driving component, and uses a control module to adjust the driving mode of the scanning head and the printer head.

The system includes a scanning module for scanning an objects image pattern, a printing module for printing the objects image pattern. Wherein the printing module is incorporated in the scanning module, a motor drive for driving the scanning module and the printing module, a control module for adjusting the driving mode of the scanning module and the printing module, thereby showing the image pattern of the objects on printing paper by using the printing module function.

FIG. 2 is the cross section view of a scanning module incorporated with a printer head according to the present invention.

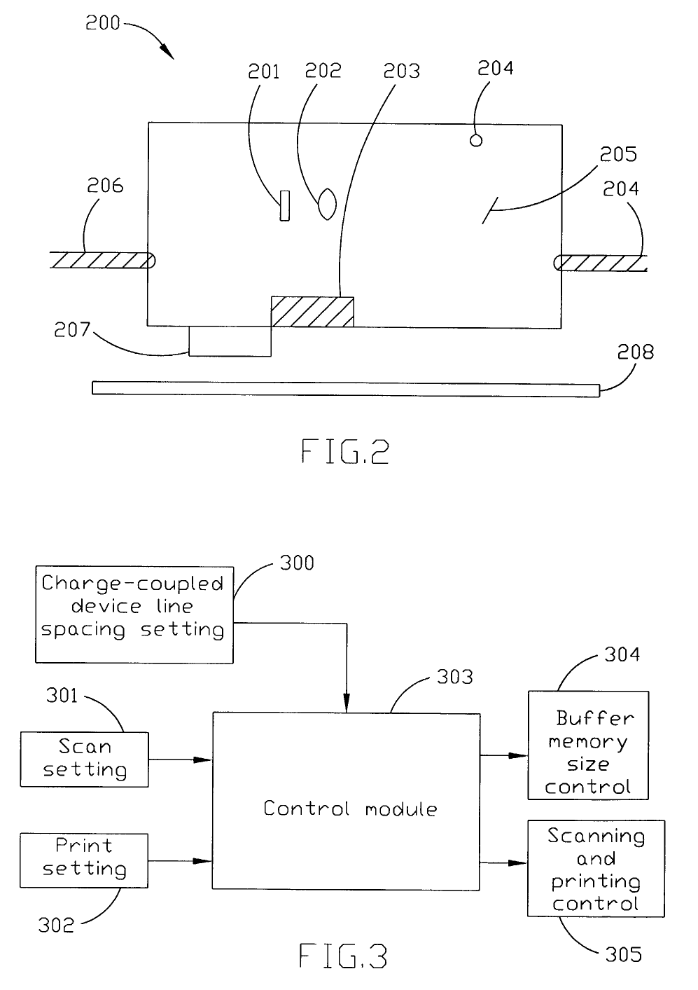

FIG. 3 is the flow chart of a scanning module system, incorporated with a printer head according to the present invention.

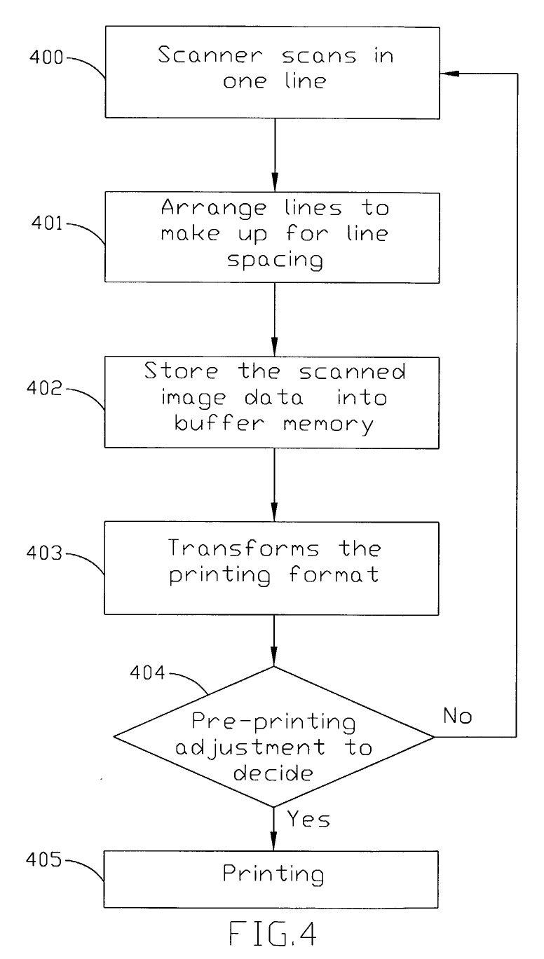

FIG. 4 is the flow chart of a method for a scanning module incorporated with a printer head according to the present invention.

In the invention, the printing module is incorporated in the scanning module, and uses the same motor drive module. The numbers of scanning steps and the driving modes of the printer head are decided by scanning resolution and printing mode. The scanning module, printing module and control module decide the buffer memory size, in color transformation. Furthermore, the used memory size can be decided by selecting the scanning and printing speed. In the present invention, by incorporating the printing module in scanning module you can reduce one set of motor drives and driving components, which can save the cost of material. Moreover, the printing module incorporated in the scanning module can save volume.

Further, the system of the invention can adjust the scanning and driving mode by using a control module. For example, some of the control module input scan settings are, resolution, scanning scope, exposing time, color scanning, grayscale scanning and monochrome scanning, etc. For example, printing data includes, printing scope, printing quality, printing mode and printing speed, etc. The outputs of the control module include control of the motor and printing speed, the buffer memory size, line spacing compensation in the sensor color scanning and printing format transformation, etc.

Referring to FIG. 2, reference number 200 is a scanning head. The scanning head 200 includes reference number 201 sensor, reference number 202 lens, reference number 203 control mode and circuit board, reference number 204 light source, reference number 205 reflection lens, reference number 206 driving guide stick or belt, reference number 207 printer head and reference number 208 printing paper. The same motor drives the scanning head 200 and printer head 207. Adding a clutch in front of the gear drives and switching in good time performs the above action. The same motor drive is used for the scanning head 200 and printer head 207, wherein the printer head of the printing module transversely moves and prints one time, thereby scanning and exposing one line.

After scanning the plurality of a line, the printer head moves one time and simultaneously prints the plurality line. Furthermore, scanning and printing needs the buffer memory size depending on the various settings. Thus, in the invention, the printing module incorporated in the scanning module can save volume and position space, and material cost. And, this only needs one motor driving device to drive the above scanning head 200 and printer head 207. It is a benefit to minimize.

FIG. 3 is the chart of a system, control module 303 manages to adjust the scanning and driving mode. The inputs include block 300 charge-coupled device line spacing setting, block 301 scan setting and block 302 print setting. The block 301 scan setting includes resolution, scanning scope, exposing time, color scanning, grayscale scanning and momochrome scanning, etc. The block 302 print setting includes printing scope, printing quality, printing mode and printing speed, etc. The output of the control module 303 includes block 304 buffer memory size control and block 305 scanning and printing control.

FIG. 4 is the flow chart of a method of scanning module incorporated with a printer head according to the present invention. Block 400 represents what the scanner scans in one line. Next, it executes block 401. The block 401 means that arranges lines to make up for the line spacing. Moreover, it executes block 402 that stores the scanned image data into the buffer memory. Next, it executes block 403 that transforms the printing format. Finally, it executes block 404 pre-printing adjustment to decide “yes” or “no”. If the answer is “yes”, block 405 executes printing. If the answer is “no”, block 400 goes back to start again.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. Thus, while the preferred embodiment of the invention has been illustrated and described, it will be appreciated that various changes can be made therein without departing from the spirit and scope of the invention.

What is claimed is:

1. A system of scanning module incorporated with a printer head comprising:
a scanning module for scanning an object image pattern;
a printing module for printing said object image pattern, wherein said printing module is incorporated in said scanning module;
a motor drive for driving said scanning module and said printing module;and
a control module for adjusting the driving mode of said scanning module and said printing module, thereby showing said object image pattern on printing paper by using said printing module function.

2. The system of claim 1, wherein said scanning module comprises a plurality of scan settings.

3. The system of claim 2, wherein said scan setting is selected from the group consisting of resolution, scanning scope, exposing time, color scanning grayscale scanning and monochrome scanning.

4. The system of claim 1, wherein said scanning module comprises a plurality of print settings.

5. The system of claim 1, wherein said print setting is selected from the group consisting of printing scope, printing quality, printing mode and printing speed.

6. The system of claim 1, wherein said printing module comprises scanning and exposing one line in printer head transverse moving one time.

7. The system of claim 1, wherein said scanning module and printing module have a buffer memory, said buffer memory size depending on various said settings.

8. The system of claim 1, wherein said the printer head moves one time and simultaneously prints the plurality line after scanning the plurality of a line.

9. The system of claim 8, wherein said scanning module prints one time again after scanning the plurality of a line again by said scanning module.

10. The system of claim 1, wherein said printer head of said printing module transversely moves and prints one time, thereby scanning and exposing one line.

11. A method of scanning module with incorporated printer head comprising:
using a scanning head of scanner to scan object image pattern;
using a printer head of scanner to print said object image pattern on a print paper, wherein said printer head and said scanning head use the same motor drive and driving component;and
using a control module to adjust said driving mode of said scanning head and said printer head.

12. The method of claim 11, wherein said scanner comprises a plurality of scan settings.

13. The method of claim 12, wherein said scan setting is selected from the group consisting of resolution, scanning scope, exposing time, color scanning, grayscale scanning and monochrome scanning.

14. The method of claim 11, wherein said scanner comprises a plurality of print settings.

15. The method of claim 14, wherein said print setting is selected from the group consisting of printing scope, printing quality, printing mode and printing speed.

16. The method of claim 11, wherein said printing module comprises scanning and exposing one line in printer head transverse moving one time.

17. The method of claim 11, wherein said scanning module and printing module need a buffer memory, said buffer memory size depending on various said setting.

18. The method of claim 11, wherein said the printer head moves one time and simultaneously prints the plurality line after scanning the plurality of a line.

19. The method of claim 18, wherein said scanning module prints one time again after scanning the plurality of a line again by said scanning module.

20. The method of claim 11, wherein said printer head of said printing module transversely moves and prints one time, thereby scanning and exposing one line.
